(19) United States
(12) Patent Application Publication
(10) Pub. No.: US 2026/0340218 A1
(43) Pub. Date: Oct. 29, 2026

(54) MACHINE LEARNING-BASED CONVERSION OF SCHEMATIC DIAGRAMS

(71) Applicant: Siemens Industry Software Inc., Plano, FL (US)

(72) Inventors: Dan Yu, Fremont, CA (US); Joseph McDonald, Wilsonville, OR (US); Artem V. Kornilov, Orlando, FL (US)

(73) Assignee: Siemens Industry Software Inc., Plano, FL (US)

(21) Appl. No.: 19/111,490

(22) PCT Filed: Sep. 28, 2022
(86) PCT No.: PCT/US2022/077141

§ 371 Date: Mar. 13, 2025

(51) Int. Cl. G06F 30/18; G06F 30/27

(52) U.S. Cl. CPC G06F 30/18; G06F 30/27

(57) ABSTRACT

A computing system can parse a schematic diagram illustrating an electronic system to identify design blocks and wire lines coupled to the design blocks in the schematic diagram. The computing system, implementing at least one supervised machine-learning classification algorithm, can classify the design blocks and the wire lines. The classification of the design blocks can correspond to one or more symbols representing components of the electronic system. The classification of the wire lines can correspond to one or more links representing connectivity for at least one of the components of the electronic system. The computing system can generate a system design describing the electronic system based, at least in part, on the symbols representing the components of the electronic system classified to the design blocks and the links representing connectivity for at least one of the components of the electronic system classified to the wire lines.

### TECHNICAL FIELD

This application is generally related to electronic design automation and, more specifically, to machine learning-based conversion of schematic diagrams.

### BACKGROUND

The design of electronic systems, such as wiring harnesses for implementation into vehicles, aircraft, boats, appliances, or other systems with distributed electronics, can include many different design stages or phases at different levels of abstraction. For example, some of the design phases can include a requirements phase, a functional phase, a logical phase, a physical or wiring phase, a components phase, a form board or manufacturing phase, and a documentation phase.

Designers of these electronic systems often utilize software-based electronic design automation tools to traverse the various design phases during the development and implementation of a wiring harness design. When designers transition between electronic design automation tools supported by different vendors, the migration of design data between the electronic design automation tools can be a difficult, time-consuming, and error-prone task. For example, many existing electronic design automation tools export design data as schematic drawings typically devoid of metadata, which are often manually converted into a format native to electronic design automation tools importing the design data. There have been some attempts to alleviate the manual conversion process, for example, by using heuristics-based translation software. Since heuristics-based translation software typically corresponds to a specific type of schematic drawing having a certain style, abstraction, and/or drafter preferences, it becomes impractical to develop numerous different heuristics-based translation software programs capable of handling the conversionof the large variety of different types of schematic drawings to import into the electronic design automation tools.

### SUMMARY

This application discloses a computing system to parse a schematic diagram illustrating an electronic system to identify design blocks and wire lines coupled to the design blocks in the schematic diagram. The computing system, implementing at least one supervised machine-learning classification algorithm, can classify the design blocks and the wire lines. The classification of the design blocks can correspond to one or more symbols representing components of the electronic system. The classification of the wire lines can correspond to one or more links representing connectivity for at least one of the components of the electronic system. The computing system can generate a system design describing the electronic system based, at least in part, on the symbols representing the components of the electronic system classified to the design blocks and the links representing connectivity for at least one of the components of the electronic system classified to the wire lines. Embodiments will be described in greater detail below.

### DESCRIPTION OF THE DRAWINGS

FIGS. 1 and 2 illustrate an example of a computer system of the type that may be used to implement various embodiments.

FIGS. 3A and 3B illustrate an example platform design system according to various embodiments.

FIG. 4 illustrates an example design conversion system with a machine learning-based schematic translation system according to various embodiments.

FIG. 5 illustrates a flow chart example of machine learning-based schematic translation of schematic diagrams according to various embodiments.

FIG. 6 illustrates an example schematic translation system with machine learning-based classification according to various embodiments.

### DETAILED DESCRIPTION

### Illustrative Operating Environment

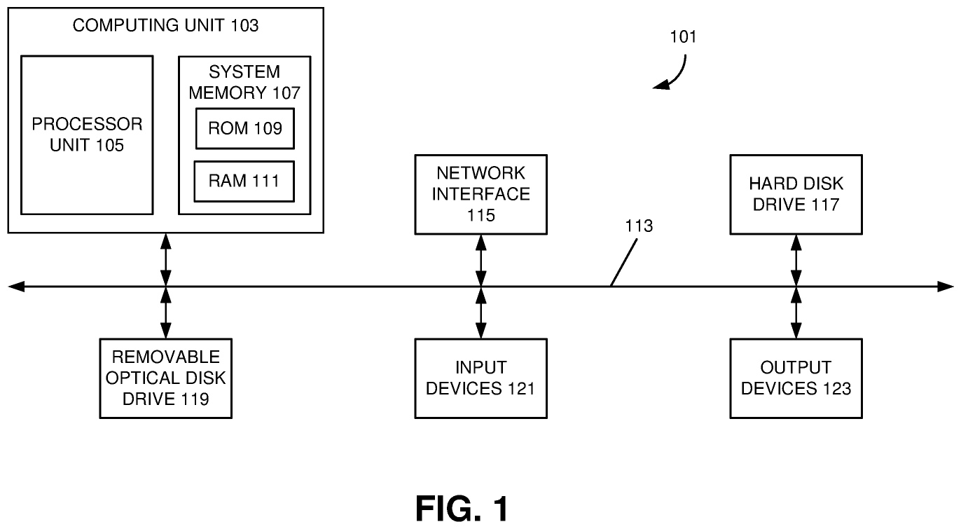

Various examples of the invention may be implemented through the execution of software instructions by a computing device, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

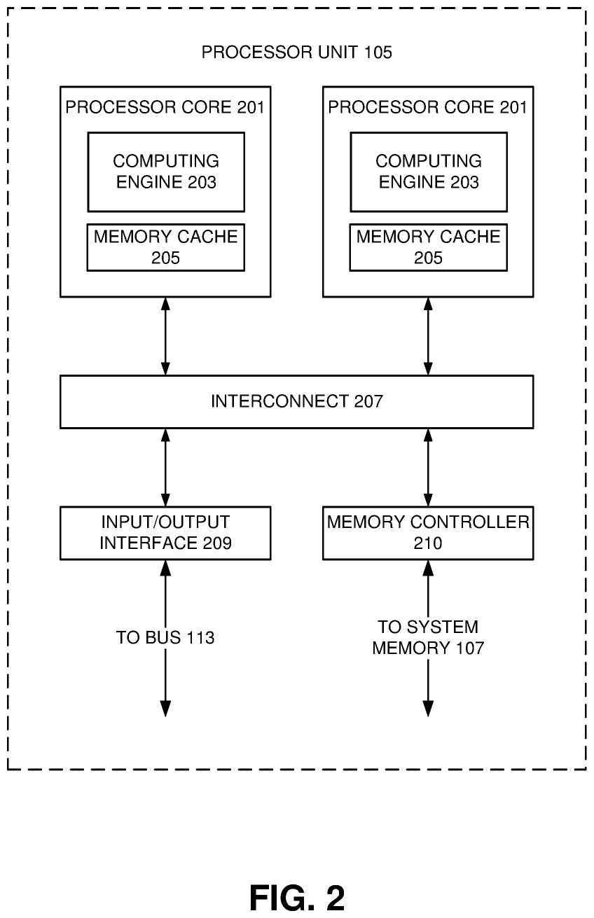

With some implementations of the invention, the processor unit 105 can have more than one processor core. Accordingly, FIG. 2 illustrates an example of a multi-core processor unit 105 that may be employed with various embodiments of the invention. As seen in this figure, the processor unit 105 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, California, the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 113. Similarly, the memory controller 211 controls the exchange of information between the processor unit 201 and the system memory 107. With some implementations of the invention, the processor units 201 may include additional components, such as a high-level cache memory accessible shared by the processor cores 201.

It also should be appreciated that the description of the computer network illustrated in FIG. 1 and FIG. 2 is provided as an example only, and it not intended to suggest any limitation as to the scope of use or functionality of alternate embodiments of the invention.

### Illustrative Platform Design System

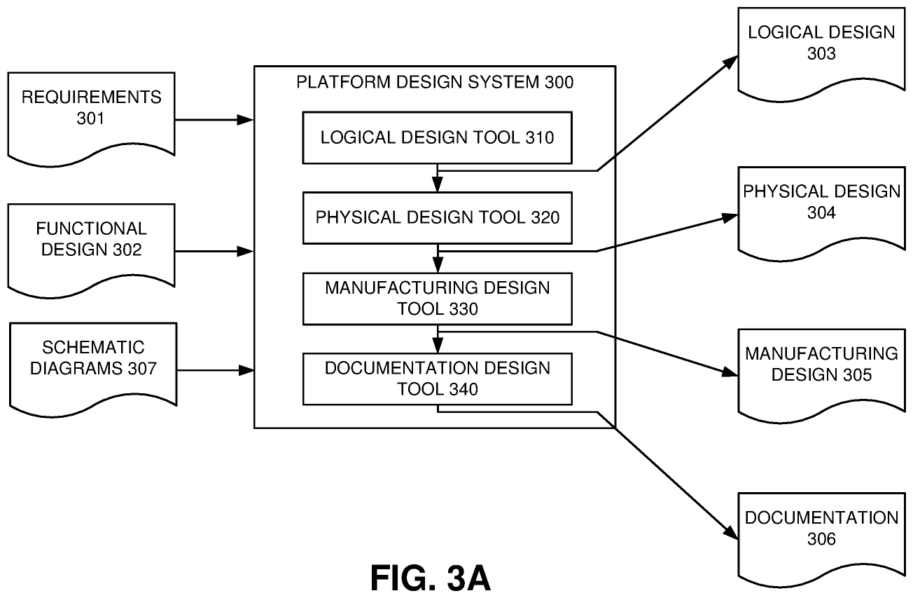

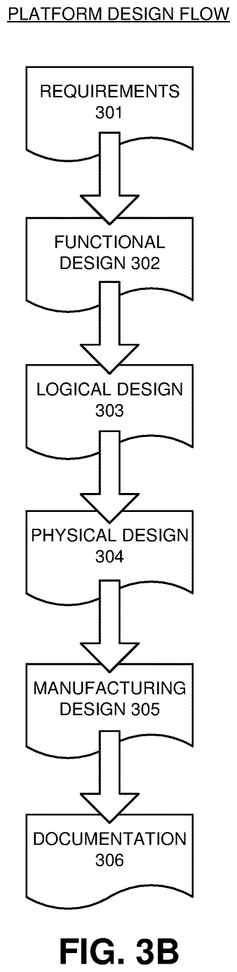

FIGS. 3A and 3B illustrate an example platform design system 300 according to various embodiments. Referring to FIGS. 3A and 3B, the platform design system 300 can include a set of one or more tools to develop at least a portion of an electronic system, such as a wiring harness. The development of the electronic system can be performed utilizing a platform design flow that includes multiple design stages, each representing the electronic system at a different level of abstraction.

The platform design flow can initially describe the electronic system as a set of requirements 301, for example, aspects, objectives, high-level operations, or the like, for the electronic system. The requirements 301 can be converted into a functional design 302, which can functionally describe the electronic system. The platform design flow continues by generating a logical design 303 for the electronic system. The logical design 303 can describe the connectivity and devices capable of implementing the functionality of the electronic system, for example, specified as a netlist or the like. The platform design flow can then include a physical design 304 that, in a wiring harness example, can describe the wires and components to physically implement the logical design 303. The platform design flow can then include a manufacturing design 305 that, in a wiring harness example, can describe specific harness components, such as mechanical structures, connectors, wire splices, or the like, as well as manufacturing aids, such as form boards, manufacturing tools, or the like. The platform design flow can include documentation 306 to describe manufacturing instructions, service or diagnostic information, decommissioning information, or the like, for the electronic system.

The platform design system 300 can include a logical design tool 310 to generate a logical design 303 for the electronic system, for example, based at least in part on the requirements 301 and the functional design 302 for the electronic system. In some embodiments, the logical design 303 can be a netlist for the electronic system, which can describe the connectivity and devices capable of implementing the functionality of the electronic system. The logical design tool 310 can receive the requirements 301 and the functional design 302 from a device external to the platform design system 300 or, in some embodiments, the platform design system 300 can include other tools (not shown) that can build or generate the requirements 301 and the functional design 302 for the electronic system.

The platform design system 300 can include a physical design tool 320 to generate a physical design 304 based, at least in part, on the logical design 303. The physical design 304, in a wiring harness example, can describe the wires and components to physically implement the logical design 303.

The platform design system 300 can include a manufacturing design tool 330 to generate a manufacturing design 305 based, at least in part, on the physical design 304. The manufacturing design 305, in the wiring harness example, can describe specific harness components, such as mechanical structures, connectors, wire splices, or the like, as well as manufacturing aids, such as form boards, manufacturing tools, or the like.

The platform design system 300 can include a documentation design tool 340 to generate documentation 306 based, at least in part, on the manufacturing design 305. The documentation 306, in the wiring harness example, can describe manufacturing instructions, service or diagnostic information, decommissioning information, or the like, for the electronic system. In some embodiments, the documentation design tool 340 can present the documentation 306 including the interactive technical file via an interactive electronic technical publication (IETP), which can provide support for fault fixing diagnostics, and maintenance of the electronic system.

The platform design system 300 can receive one or more schematic diagrams 307 that describe components as electrical or electronic diagrams. The schematic diagrams 307 can correspond to a level of abstraction associated with the logical design 303, physical design 304, manufacturing design 305, or the like. The platform design system 300 can include a machine learning-based conversion system to at least partially translate the schematic diagrams 307 into a format native to the platform design system 300, such as a format native to the logical design tool 310, the physical design tool 320, the manufacturing design tool 330, the documentation design tool 340, or the like. Embodiments of the machine learning-based conversion system will be described below in greater detail.

### Machine Learning-Based Conversion of Schematic Diagrams

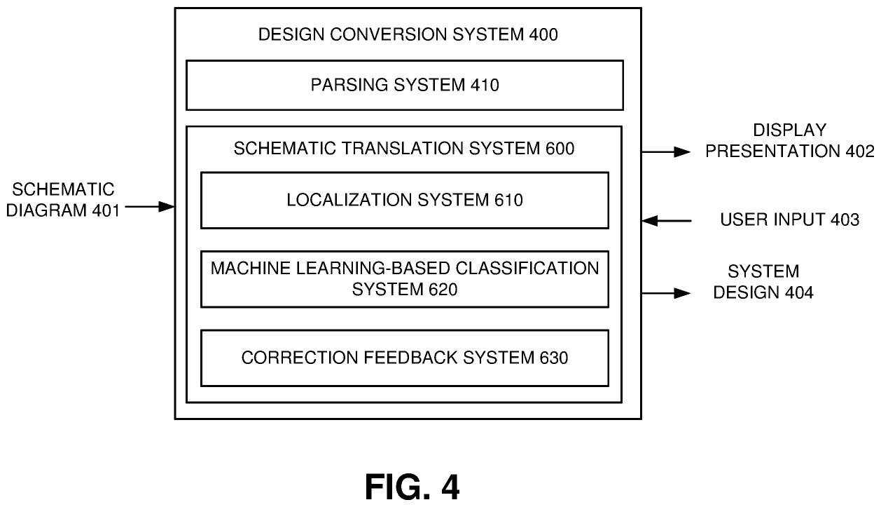

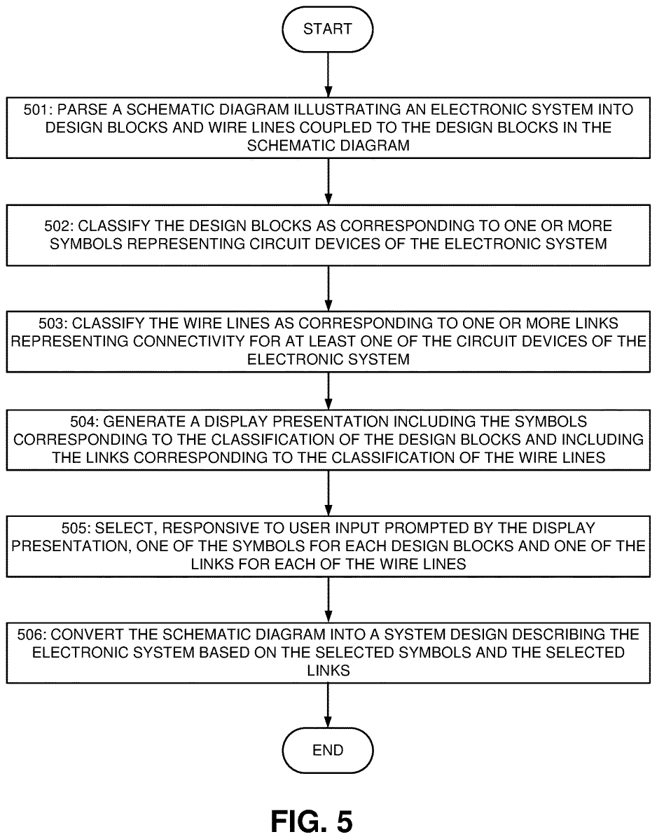

FIG. 4 illustrates an example design conversion system 400 with a machine learning-based schematic translation system 600 according to various embodiments. FIG. 5 illustrates a flow chart example of machine learning-based schematic translation of schematic diagrams according to various embodiments. Referring to FIGS. 4 and 5, the design conversion system 400 can receive a schematic diagram 401, for example, illustrating an electronic system, such as a wire harness, electrical power system, controller system, actuation system, sensor system, or the like, a mechanical system, a software system, or the like. The design conversion system 400 can convert the schematic diagram 401 into a system design 404 having a format with native compatibility to a downstream development tool, such as an electronic design automation tool. In some embodiments, the schematic diagram 401 can include one or more images providing a graphical description of the electronic system that also can include textual labeling. The schematic diagram 401 can be specified in a portable document format (PDF), scalable vector graphics (SVG) format, drawing exchange format (DXF), portable network graphics (PNG) format, or the like.

The design conversion system 400 can include a parsing system 410 that, in a block 501 of FIG. 5, can parse the schematic diagram 401, for example, illustrating the electronic system, to identify design blocks and wire lines coupled to the design blocks in the schematic diagram 401. The parsing system 410 can scan the schematic diagram 401 to identify a plurality of graphical shapes and determine whether the graphical shapes correspond to design blocks in the schematic diagram 401. The parsing system 410 also can scan the schematic diagram 401 to identify lines coupled to at least one of the graphical shapes in the schematic diagram 401 and determine whether the lines correspond to wire lines in the schematic diagram 401. In some embodiments, the parsing system 410 also can identify text located proximate to at least one of the graphical shapes and the lines, which may correspond to labeling for the design blocks or the wire lines.

The design conversion system 400 can include a schematic translation system 600 to translate the design blocks parsed from the schematic diagram 401 into symbols representing components of the electronic system and translate the wire lines parsed from the schematic diagram 401 into links representing connectivity of the electronic system. The schematic translation system 600 can utilize the symbols and the links to generate the system design 404 having a format with native compatibility to a downstream electronic design automation tool.

The schematic translation system 600 can include a localization system 610 to characterize the design blocks and the wire lines parsed from the schematic diagram 401. In some embodiments, the localization system 610 can utilize the schematic diagram 401 to identify coordinates of the design blocks and the wire lines in the schematic diagram 401. The localization system 610 also can associate text in the schematic diagram 401 to the design blocks and/or the wire lines as labeling, for example, based on a proximity of the text to the design blocks and wire lines.

The schematic translation system 600 can include a machine-learning based classification system 620 that, in a block 502 of FIG. 5, can classify the design blocks as corresponding to one or more symbols representing components of the electronic system. The machine-learning based classification system 620 can implement at least one machine-learning algorithm, for example, a supervised neural network model having been trained with design block-symbol pairs, to associate the design blocks with a set of one or more symbols. Each of the associated symbols corresponds to a classification of the design block as corresponding to the symbol, for example, that the design block and the symbol represent common components of the electronic system. In some embodiments, the machine-learning algorithm can set confidence levels that the classifications of the design block to the symbols in a set.

The machine-learning based classification system 620, in a block 503 of FIG. 5, can classify the wire lines as corresponding to one or more links representing connectivity for at least one of the components of the electronic system. The machine-learning based classification system 620 can implement at least one machine-learning algorithm, for example, a supervised neural network model having been trained with wire line-link pairs, to associate the wire lines with a set of one or more links. Each of the associated links corresponds to a classification of the wire lines as corresponding to the wire lines, for example, that the wire lines and the links represent common connectivity in the electronic system. In some embodiments, the machine-learning algorithm can set confidence levels that the classifications of the wire lines to the links in a set.

The schematic translation system 600 can include a correction feedback system 630 that, in a block 504 of FIG. 5, can generate a display presentation 402 including the symbols corresponding to the classification of the design blocks and including the links corresponding to the classification of the wire lines. In some embodiments, the display presentation 402 also can include a display of the design blocks and wire lines used by the machine learning-based classification system 620 to identify the symbols and links, respectively. The correction feedback system 630 can include the confidence levels associated with the classification of the design blocks and the classification of the wire lines in the display presentation 402 and/or order the presentation of the symbols and/or the links in the display presentation 402 based on the confidence levels associated with the classification of the design blocks and the classification of the wire lines. The correction feedback system 630, in some embodiments, can output the display presentation 402 for manual review of the classifications of the design blocks and the classifications of the wire lines. The correction feedback system 630 can receive user input 403 based on the display presentation 402.

The correction feedback system 630, in a block 505 of FIG. 5, can select one of the symbols for each design blocks and one of the links for each of the wire lines based on the user input 403. In some embodiments, the user input 403 can identify which of the classified symbols in the display presentation 402 that a user identifies as corresponding to the design blocks and/or identify which of the classified links in the display presentation 402 the user identifies as corresponding to the wire lines. The correction feedback system 630 can utilize the user input 403 to finalize the classification of each design block and each wire line in the schematic diagram 401 to a corresponding symbol and link, respectively.

The correction feedback system 630, in some embodiments, can utilize the user input 403 to generate additional training data for the machine learning-based classification system 620. In some examples, the correction feedback system 630 can build additional design block-symbol pairs corresponding to the finalized classification of the design blocks to particular symbols based on the user input 403. The correction feedback system 630 also can build an additional wire line-link pairs corresponding to the finalized classification of the wire lines to particular links based on the user input 403. The correction feedback system 630 can provide the design block-symbol pairs and/or the wire line-link pairs to the machine learning-based classification system 620 for use in retraining one or more of the machine-learning algorithms utilized for classifying design blocks and/or wire lines.

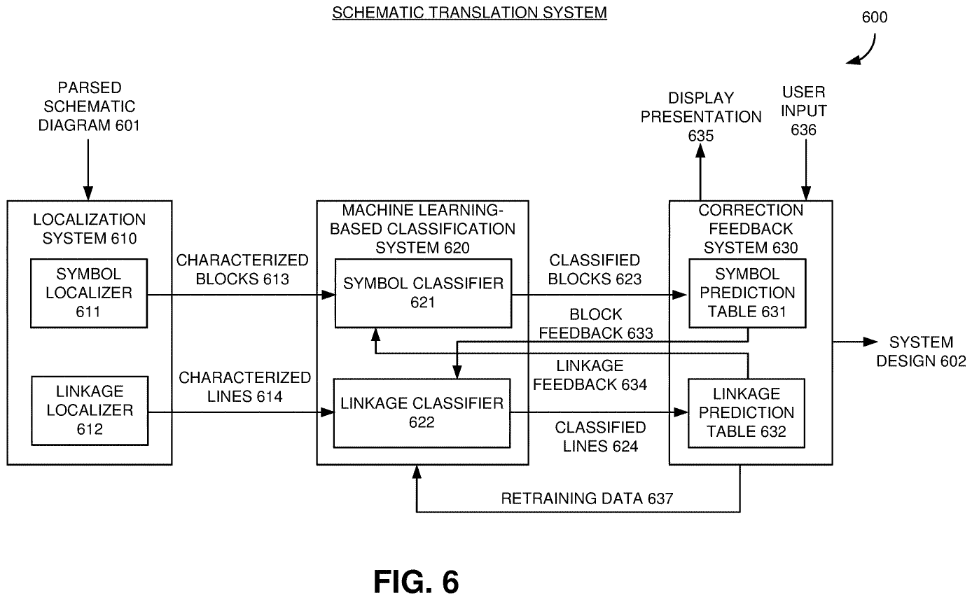

The schematic translation system 600, in a block 506 of FIG. 5, can convert the schematic diagram into the system design 404 describing the electronic system based on the selected symbols and the selected links. In some embodiments, the schematic translation system 600 can utilize the coordinates of the design blocks identified by the localization system 610 to set the selected symbols in the system design 404. The schematic translation system 600 can set the connectivity in the system design 404, for example, by applying connections to the selected symbols based on the selected links and the associated coupling of the wire lines to the design blocks in the schematic diagram 401. Embodiments of the schematic translation system 600 will be described in greater detail with reference to FIG. 6.

FIG. 6 illustrates an example schematic translation system with machine learning-based classification according to various embodiments. Referring to FIG. 6, the schematic translation system 600 can receive a parsed schematic diagram 601 similar to the schematic diagram 401 in FIG. 4, which can be specified in a portable document format (PDF), scalable vector graphics (SVG) format, drawing exchange format (DXF), portable network graphics (PNG) format, or the like. The parsed schematic diagram 601 can include design blocks corresponding to graphical shapes and include wire lines coupled to the design blocks. In some embodiments, the parsed schematic diagram 601 can include text that can correspond to labeling for the design blocks or the wire lines.

The schematic translation system 600 can include a localization system 610 to characterize the design blocks and the wire lines parsed from the parsed schematic diagram 601. The localization system 610 can include a symbol localizer 611 and a linkage localizer 612 to separately characterize the design blocks and the wire lines, respectively, and output characterized block 613 and characterized links 614, respectively. The symbol localizer 611 can utilize design blocks to identify coordinates of the design blocks in the parsed schematic diagram 601. The symbol localizer 611 also can associate text in the parsed schematic diagram 601 to the design blocks as labeling, for example, based on a proximity of the text to the design blocks. The symbol localizer 611 can annotate the design blocks with the coordinates and optionally any associated text labels to generate the characterized blocks 613.

The linkage localizer 612 can utilize wire lines to identify coordinates of the wire lines in the parsed schematic diagram 601. The linkage localizer 612 also can associate text in the parsed schematic diagram 601 to the wire lines as labeling, for example, based on a proximity of the text to the wire lines. The linkage localizer 612 can annotate the wire lines with the coordinates and optionally any associated text labels to generate the characterized lines 614.

The schematic translation system 600 can include a machine-learning based classification system 620 to classify the characterized blocks 613 as corresponding to one or more symbols representing components of the electronic system, to classify the characterized lines 614 as corresponding to one or more links representing connectivity in the electronic system. The machine-learning based classification system 620 can include a symbol classifier 621 and a linkage classifier 622 to separately classify the characterized blocks 613 and the characterized links 614, respectively.

The symbol classifier 621 can implement a machine-learning algorithm, for example, a supervised neural network model having been trained with design block-symbol pairs, to associate the characterized blocks 613 with a set of one or more symbols. The symbol classifier 621 can output a classification of the characterized blocks 613, called classified blocks 623, which can include an aggregation of the symbols that the symbol classifier 621 associated with the characterized blocks 613.

The linkage classifier 622 can implement a machine-learning algorithm, for example, a supervised neural network model having been trained with wire line-link pairs, to associate the characterized lines 614 with a set of one or more links. The linkage classifier 622 can output a classification of the characterized lines 614, called classified lines 624, which can include an aggregation of the links that the linkage classifier 622 associated with the characterized lines 614.

The schematic translation system 600 can include a correction feedback system 630 to receive the classified blocks 623 and the classified links 624, and to verify or augment the classifications for the characterized blocks 613 and the characterized lines 614. In some embodiments, the correction feedback system 630 can include a symbol prediction table 631 to store the received classified blocks 623 and include a linkage prediction table 632 to store the received classified lines 624.

The correction feedback system 630 can utilize the classified blocks 623 stored in the symbol prediction table 631 and the classified lines 624 stored in the linkage prediction table 632 in several ways. In some embodiments, the correction feedback system 630 can utilize the classified blocks 623 and/or the classified lines 624 as a feedback to the machine learning-based classification system 620. For example, the correction feedback system 630 can provide one or more of the classified blocks 623 to the linkage classifier 622 as a block feedback 633. Since there can be a relationship between a symbol and a link coupled to the symbol in an electronic design, the ability to provide at least a portion of the classified blocks 623 to the linkage classifier 622 can allow for a more robust classification of the characterized lines 614. The correction feedback system 630 also can provide one or more of the classified lines 624 to the symbol classifier 621 as a linkage feedback 634. Similar to the block feedback 633 described above, since there can be a relationship between a symbol and a link coupled to the symbol in an electronic design, the ability to provide at least a portion of the classified lines 624 to the symbol classifier 621 can allow for a more robust classification of the characterized blocks 613. The correction feedback system 630 and the machine learning-based classification system 620 can iteratively classify the characterized blocks 613 and characterized lines 614 through this feedback loop to determine the classified blocks 623 and the classified lines 624.

In some embodiments, the correction feedback system 630 can perform verification operations on the classified blocks 623, for example, by generating a display presentation 635 including the symbols corresponding to the classified blocks 623 and including the links corresponding to the classified lines 624. The display presentation 635 also can include a display of the design blocks and wire lines used by the machine learning-based classification system 620 to identify the symbols and links, respectively. The correction feedback system 630 can include the confidence levels associated with the classification of the design blocks and the classification of the wire lines in the display presentation 635 and/or order the presentation of the symbols and/or the links in the display presentation 635 based on the confidence levels associated with the classified blocks 623 and the classified lines 624. In some embodiments, the correction feedback system 630 can correlate symbols and links from the classified blocks 623 and classified lines 624, respectively, into pairs of symbols and links usable together in an electronic system. For example, when a component represented by a particular symbol has the capability to connect through certain types of links, the correction feedback system 630 can selectively pair the particular symbol to links in the classified lines 624 based on the component capability.

The correction feedback system 630, in some embodiments, can output the display presentation 635 for manual review of the classifications of the design blocks and the classifications of the wire lines. The correction feedback system 630 can receive user input 636 based on the display presentation 635. The correction feedback system 630 can utilize the user input 636 to select one of the symbols for each design blocks and one of the links for each of the wire lines. In some embodiments, the user input 636 can identify which of the symbols in the display presentation 635 that a user identifies as corresponding to the design blocks and/or identify which of the links in the display presentation 635 the user identifies as corresponding to the wire lines. The correction feedback system 630 can utilize the user input 636 to verify or augment the classification of each design block and each wire line. The correction feedback system 630 can utilize the selected symbols and selected links for the characterized blocks 613 and characterized lines 614, respectively, to generate a system design 602 having a format with native compatibility to a downstream development tool, such as an electronic design automation tool.

In some embodiments, the correction feedback system 630 can utilize the selected symbols and selected links for the characterized blocks 613 and characterized lines 614, respectively, to retrain the symbol classifier 621 and the linkage classifier 622, respectively. The correction feedback system 630, in some embodiments, can generate additional training data for the machine learning-based classification system 620, for example, by building design block-symbol pairs corresponding to the selected symbols and by building wire line-link pairs corresponding to the selected links. The correction feedback system 630 can provide the design block-symbol pairs and/or the wire line-link pairs to the machine learning-based classification system 620 for use in retraining the symbol classifier 621 and the linkage classifier 622, respectively.

The correction feedback system 630 can output the system design 602 as a converted version of a schematic diagram, which can be utilized by a downstream development tool. In some embodiments, the downstream development tool may identify one or more errors in the system design 602, which could correspond to the conversion of the schematic diagram into the system design 602, and provide feedback to the schematic translation system 600. The correction feedback system 630 can perform verification operations to detect whether the error corresponded to an error in the schematic diagram or was introduced during the conversion of the schematic diagram into the system design 602. In some examples, the correction feedback system 630 can utilize the machine learning-based classification system 620 to determine a correlation between a symbol error or a line error and the characterized blocks 613 and/or the characterized lines 614, respectively. When the correction feedback system 630 determines the error was at least partially introduced during the conversion process, the correction feedback system 630 can generate additional training data for the machine learning-based classification system 620, for example, by building design block-symbol pairs corresponding to corrected symbols and by building wire line-link pairs corresponding to the corrected links. The correction feedback system 630 can provide the design block-symbol pairs and/or the wire line-link pairs to the machine learning-based classification system 620 for use in retraining the symbol classifier 621 and the linkage classifier 622, respectively. Although FIG. 6 shows the schematic translation system 600 divided into separate localization system 610, machine learning-based classification system 620, and the correction feedback system 630, in some embodiments, the schematic translation system 600 can perform the operations of these systems 610-630 in a single run through a machine learning-based system.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in a computer-readable memory device. The memory device may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory device may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory devices may be “read only” by design (ROM) by virtue of permission settings, or not. Other examples of memory devices may include, but may not be limited to, WORM, EPROM, EEPROM, FLASH, NVRAM, OTP, or the like, which may be implemented in solid state semiconductor devices. Other memory devices may comprise moving parts, such as a known rotating disk drive. All such memory devices may be “machine-readable” and may be readable by a processing device.

Operating instructions or commands may be implemented or embodied in tangible forms of stored computer software (also known as “computer program” or “code”). Programs, or code, may be stored in a digital memory device and may be read by the processing device. “Computer-readable storage medium” (or alternatively, “machine-readable storage medium”) may include all of the foregoing types of computer-readable memory devices, as well as new technologies of the future, as long as the memory devices may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### Conclusion

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to computing processes, it should be appreciated that various examples of the invention may be implemented using any desired combination of computing processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
parsing, by a computing system, a schematic diagram illustrating a system to identify design blocks and wire lines coupled to the design blocks in the schematic diagram;
classifying, by the computing system implementing at least one machine-learning classification algorithm, the design blocks and the wire lines, wherein the classification of the design blocks corresponds to one or more symbols representing components of the system, and wherein the classification of the wire lines corresponds to one or more links representing connectivity for at least one of the components of the system; and
generating, by the computing system, a system design describing the system based, at least in part, on the symbols representing the components of the system classified to the design blocks and the links representing connectivity for at least one of the components of the system classified to the wire lines.

2. The method of claim 1, wherein classifying the design blocks and the wire lines further comprises:
utilizing, by the computing system, a first machine-learning classification algorithm to classify the design blocks to the one or more symbols representing the components of the system; and
utilizing, by the computing system, a second machine-learning classification algorithm to classify the wire lines to the one or more links representing connectivity for at least one of the components of the system.

3. The method of claim 2, wherein the classification of the design blocks by the first machine-learning classification algorithm is based, at least in part, on the classification of the wire lines by the second machine-learning classification algorithm.

4. The method of claim 2, wherein the classification of the wire lines by the second machine-learning classification algorithm is based, at least in part, on the classification of the design blocks by the first machine-learning classification algorithm.

5. The method of claim 1, wherein classifying the design blocks and the wire lines includes identifying multiple potential symbols and multiple potential links, wherein the classification of the design blocks corresponds to symbols selected from the multiple potential symbols, and wherein the classification of the wire lines corresponds links selected from the multiple potential links.

6. The method of claim 5, further comprising:
generating, by the computing system, a display presentation including the potential symbols and potential links identified by the machine-learning classification algorithm implemented by the computing system; and
responsive to input prompted by the display presentation, selecting, by the computing system, both the symbols corresponding to the classification of the design blocks from the multiple potential symbols and the links corresponding to the classification of the wire lines from the multiple potential links.

7. The method of claim 1, wherein the at least one machine-learning classification algorithm implemented by the computing system corresponds to a supervised neural network trained with training design blocks labeled with identifiers corresponding to training symbols.

8. A system comprising:
a memory device configured to store machine-readable instructions; and
a computing system including one or more processing devices, in response to executing the machine-readable instructions, configured to:
parsing a schematic diagram illustrating a system to identify design blocks and wire lines coupled to the design blocks in the schematic diagram;
classify, by at least one machine-learning classification algorithm implemented with the computing system, the design blocks and the wire lines, wherein the classification of the design blocks corresponds to one or more symbols representing components of the system, and wherein the classification of the wire lines corresponds to one or more links representing connectivity for at least one of the components of the system;
generate a system design describing the system based, at least in part, on the symbols representing the components of the system classified to the design blocks and the links representing connectivity for at least one of the components of the system classified to the wire lines.

9. The system of claim 8, wherein the one or more processing devices, in response to executing the machine-readable instructions, are configured to:
utilize a first machine-learning classification algorithm to classify the design blocks to the one or more symbols representing the components of the system; and
utilize a second machine-learning classification algorithm to classify the wire lines to the one or more links representing connectivity for at least one of the components of the system.

10. The system of claim 9, wherein the classification of the design blocks by the first machine-learning classification algorithm is based, at least in part, on the classification of the wire lines by the second machine-learning classification algorithm.

11. The system of claim 9, wherein the classification of the wire lines by the second machine-learning classification algorithm is based, at least in part, on the classification of the design blocks by the first machine-learning classification algorithm.

12. The system of claim 8, wherein the one or more processing devices, in response to executing the machine-readable instructions, are configured to classify the design blocks and the wire lines by identifying multiple potential symbols and multiple potential links, wherein the classification of the design blocks corresponds to symbols selected from the multiple potential symbols, and wherein the classification of the wire lines corresponds links selected from the multiple potential links.

13. The system of claim 12, wherein the one or more processing devices, in response to executing the machine-readable instructions, are configured to:
generate a display presentation including the potential symbols and potential links identified by the machine-learning classification algorithm implemented by the computing system; and
responsive to input prompted by the display presentation, select both the symbols corresponding to the classification of the design blocks from the multiple potential symbols and the links corresponding to the classification of the wire lines from the multiple potential links.

14. An apparatus including a memory device storing instructions configured to cause one or more processing devices to perform operations comprising:
parsing a schematic diagram illustrating a system to identify design blocks and wire lines coupled to the design blocks in the schematic diagram;
classifying, by at least one machine-learning classification algorithm, the design blocks and the wire lines, wherein the classification of the design blocks corresponds to one or more symbols representing components of the system, and wherein the classification of the wire lines corresponds to one or more links representing connectivity for at least one of the components of the system; and
generating a system design describing the system based, at least in part, on the symbols representing the components of the system classified to the design blocks and the links representing connectivity for at least one of the components of the system classified to the wire lines.

15. The apparatus of claim 14, wherein the instructions are configured to cause one or more processing devices to perform operations further comprising classifying the design blocks and the wire lines by:
utilizing a first machine-learning classification algorithm to classify the design blocks to the one or more symbols representing the components of the system; and
utilizing a second machine-learning classification algorithm to classify the wire lines to the one or more links representing connectivity for at least one of the components of the system.

16. The apparatus of claim 15, wherein the classification of the design blocks by the first machine-learning classification algorithm is based, at least in part, on the classification of the wire lines by the second machine-learning classification algorithm.

17. The apparatus of claim 15, wherein the classification of the wire lines by the second machine-learning classification algorithm is based, at least in part, on the classification of the design blocks by the first machine-learning classification algorithm.

18. The apparatus of claim 14, wherein classifying the design blocks and the wire lines includes identifying multiple potential symbols and multiple potential links, wherein the classification of the design blocks corresponds to symbols selected from the multiple potential symbols, and wherein the classification of the wire lines corresponds links selected from the multiple potential links.

19. The apparatus of claim 18, wherein the instructions are configured to cause one or more processing devices to perform operations further comprising:
generating a display presentation including the potential symbols and potential links identified by the machine-learning classification algorithm; and
responsive to input prompted by the display presentation, selecting, by the computing system, both the symbols corresponding to the classification of the design blocks from the multiple potential symbols and the links corresponding to the classification of the wire lines from the multiple potential links.

20. The apparatus of claim 14, wherein the at least one machine-learning classification algorithm implemented by the computing system corresponds to a supervised neural network trained with training design blocks labeled with identifiers corresponding to training symbols.
